(19) United States
(12) Patent Application Publication
(10) Pub. No.: US 2019/0325511 A1
(43) Pub. Date: Oct. 24, 2019

(54) Augmented Reality Foreign Currency View

(71) Applicant: Wells Fargo Bank N.A., San Francisco, CA (US)

(72) Inventors: Aaron Robert Taylor, Plymouth, MN (US); Kourtney Eidam, Marietta, GA (US); Jasvir K. Singh, Saint Anthony Village, MN (US); Kristine Collings, Charlotte, NC (US)

(21) Appl. No.: 14/328,343

(22) Filed: Jul. 10, 2014

(51) Int. Cl. G06Q 40/00; G06T 19/00

(52) U.S. Cl. CPC G06Q 40/00; G06T 19/006

(57) ABSTRACT

A method implemented on an augmented reality (AR) device includes receiving an image of an item from which a monetary value may be identified. The monetary value is in a foreign currency. An action is processed to obtain currency exchange rate information for the item. The currency exchange rate information is obtained from a server computer. The currency exchange rate information is displayed on an optical display of the AR device.

### BACKGROUND

Augmented reality is a technology in which a person's conception of reality can be enhanced, typically through augmented sound, video or graphics displays. The augmentation is typically implemented via various technologies, such as a headset that may be worn by the person. One or more augmented views may be presented to the person through the headset.

The augmented reality headset typically includes a wearable computer and an optical display mounted to the headset. The wearable computer may include a wireless telecommunication capability, permitting a wireless connection from the wearable computer to a server computer. Because of the wireless telecommunication capability, the augmented reality headset may be used to interact with the server computer to accomplish various tasks.

### SUMMARY

Embodiments of the disclosure are directed to a method implemented on an augmented reality (AR) device. The method comprises: on the AR device, receiving an image of an item from which a monetary value may be identified, the monetary value being in a foreign currency; on the AR device, processing an action to obtain currency exchange rate information for the item; obtaining the currency exchange rate information from a server computer; and displaying the currency exchange rate information on an optical display of the AR device.

In another aspect, a method implemented on an augmented reality (AR) electronic device comprises: on the AR device receive an image of a banknote; determining a local currency associated with the banknote; sending a request to a server computer to obtain an exchange rate for the local currency, the exchange rate being in a currency preconfigured for the user of the AR device; receiving the exchange rate from the server computer; and displaying the exchange rate on an optical display of the AR device.

In yet another aspect, an augmented reality (AR) electronic device comprises: a processing unit; and system memory, the system memory including instructions which, when executed by the processing unit, cause the AR device to: receive an image of a banknote, the banknote being in a foreign currency; process an action to obtain a currency exchange rate for the banknote; obtain the currency exchange rate from a server computer; calculate a monetary value for the banknote in a currency preconfigured for a user of the AR electronic device, the calculation using the currency exchange rate obtained from the server computer; obtain information from the server computer regarding nearby locations at which a currency exchange may be performed, the information including any fees and discounts provided for the user at the nearby locations; display the currency exchange rate information on an optical display of the AR device; display the calculated monetary value for the banknote on the optical display of the AR device; and display a locator map on the optical display of the AR device, the locator map showing a location of currency exchanges nearby a current position of the AR device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an augmented reality (AR) foreign currency view.

FIG. 2 shows example modules of the AR devices of FIG. 1.

FIG. 3 shows an example quick response code that may appear on the item to be scanned of FIG. 1.

FIG. 4 shows a flowchart for an example method implemented on an AR device of FIG. 1 for obtaining and displaying currency exchange information.

FIG. 5 shows another flowchart for an example method implemented on an AR device of FIG. 1 for obtaining and displaying currency exchange information.

FIG. 6 shows example physical components of the AR device of FIG. 1.

### DETAILED DESCRIPTION

The present disclosure is directed to systems and methods for displaying currency exchange rate information on an augmented reality (AR) device. In example implementations, the exchange rate information may be a current exchange rate, a monetary value for a banknote in a specific currency based on the exchange rate, a price of an item to be purchased in the specific currency based on the exchange rate or a combination of the exchange rate and the monetary value. Other exchange rate information may be displayed.

In an example implementation, a user of the AR device may view a banknote of a foreign currency using the AR device. For example, the user may be in Italy and may view a banknote with a face value of 20 euros. The user may want to know a current exchange rate for the euro in U.S. dollars. The user may also want to know what a current value of the banknote is in U.S. dollars. The user may issue a verbal command such as “exchange to dollars.” As a result of issuing the verbal command, a current exchange rate for euros is displayed on the AR device. In addition, in some implementations, a current value for the banknote in U.S. dollars is displayed on the AR device.

In some implementations, a locator map for nearby currency exchanges may also be displayed on the AR device. The locator map typically displays addresses, hours of operation and contact information for the nearby currency exchanges. The locator map may also indicate exchange fees associated with a currency exchange and any discounts that may be available to the user. For example, the user may obtain a discount at a specific bank in which the user may have an account.

In some implementations, the user may be able to initiate a currency exchange using the AR device and lock-in an exchange rate. For example, the user may not be able to physically get to one of the currency exchanges but may wish to lock-in the current exchange rate now. In these implementations, the user may create a record of an exchange transaction and use the record of the exchange transaction at a later date to implement the currency exchange at the exchange rate that is locked in.

In another example implementation, the user may be in a foreign country and may wish to purchase an item of merchandise. The item to be purchased may include a price tag that displays a price of the item in a local currency, such as euros. The user may view the item to be purchased with the AR device and issue a verbal command such as “price in dollars.” As a result of issuing the verbal command, the price of the item to be purchased is translated from the local currency and shown in U.S. dollars on the AR device display. Knowing the price of the item in U.S. dollars may help the user decide whether to purchase the item.

In some implementations, the user may also obtain budgeting information relating to a currency exchange and have the budgeting information displayed on the AR device. For example, if the user is on a vacation trip and makes a purchase, a specific monetary value may be subtracted from a budget for the trip and displayed on the AR device. For example, the specific monetary value may comprise a price for the purchased item in a currency preconfigured for the user, for example in U.S. dollars. The specific monetary value may also include any fees associated with the currency exchange. The budgeting information displayed on the AR device may include the specific monetary value for the item and the remaining amount in the budget for the trip. Other budgeting information may also be displayed on the AR device.

In some implementations, the AR device may provide help to a user who is on a business trip in a foreign country. The AR device may scan expense receipts for the user and calculate an expense total for the user based on a local currency preconfigured for the user, for example U.S. dollars. Calculating the expense total in the local currency preconfigured for the user provides the user with an actual cost of expenses for the business trip, which may include exchange and other fees. The AR device may also generate an expense report for the user including one or more of the expense receipts. The AR device may display the expense report for the user on the AR device.

In some implementations, the AR device may scan a quick response (QR) code to obtain an exchange rate. For example, the QR code may be displayed on a document, for example a banking document. When the AR device scans the QR code, the AR device may obtain an address of a server computer from which to obtain the exchange rate. Using the QR code may be a faster way to obtain the exchange rate than having to access a software application or another means for obtaining the exchange rate. The banking document may be any document that includes the QR code. For example, the bank may provide a card with information for travelers, etc. that may include the QR code. Other types of banking documents are possible.

The systems and methods are generally described for an AR device that may be worn or carried by a user. An example of and AR device that may be worn by the user is an AR headset. An example of an AR device that may be carried by the user is a smartphone or tablet computer that includes AR components such as a processor, display and camera and an AR software application.

The AR headset includes a wearable computer, a camera and an optical display. The wearable computer includes a wireless telecommunication capability, permitting a wireless connection between the wearable computer and one or more server computers. The wearable computer also includes voice recognition capability, permitting the user to direct the wearable computer via voice commands. In addition, in some implementations, the wearable computer also includes biometric capability such as facial recognition, retinal scan capability, finger print and voice print capability. The optical display reflects projected images and also permits the user to see through the display.

One type of AR headset described in this disclosure is a smart glass type of headset, similar to eyeglasses, which may be worn by the user. The user may view AR images in the glass portion of the headset. An example of a smart glass headset is Google Glass, from Google Inc. of Mountain View, Calif.

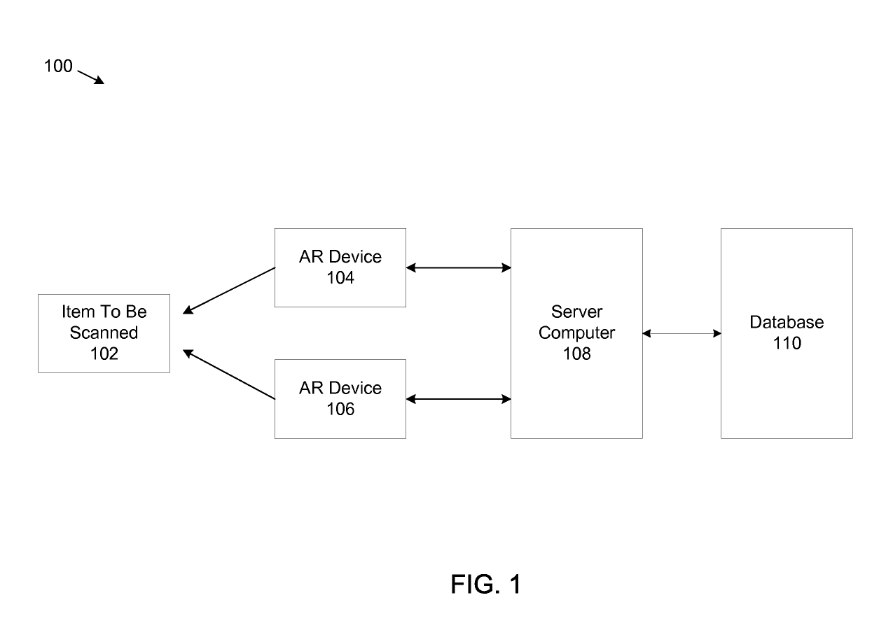

FIG. 1 shows an example system 100 that supports an AR foreign currency view. The example system 100 includes AR devices 104, 106, server computer 108, database 110 and an item to be scanned 102. The item to be scanned 102 may be a banknote in a foreign currency, a price tag of an item to be purchased or an item having a QR code. Other items to be scanned 102 are possible. In system 100, AR device 104 is a headset device and AR device 106 is a smartphone.

In an example implementation using system 100, a user is travelling in a foreign country, for example France, and wishes to know a current exchange rate for euros in France. The user is wearing an AR headset device, for example AR device 104. The user views a banknote having a denomination in euros with AR device 104. The user also issues a verbal command such as “exchange to dollars.”

When the user issues the verbal command, currency exchange software is activated on AR device 104. In some implementations, the currency exchange software may be a software application on AR device 104. In other implementations, the currency exchange software may be included in a software module on AR device 104.

Typically when the currency exchange software is activated, a connection is established from AR device 104 to server computer 108. Server computer 108 is a server computer associated with a financial institution such as a bank. Typically, AR device 104 is pre-configured with an address of server computer 108 so that when the verbal command is issued, AR device 104 may connect to server computer 108. Server computer 108 may be located anywhere in the world. The AR device 104 is programmed to communicate with the server computer 108 to determine such information as current exchange rates, locations for currency exchanges, etc. GPS software on AR device 104 may determine a current location for the user.

When the connection is established between AR device 104 and server computer 108, AR device 104 sends server computer 108 a request for an exchange rate for euros in the country in which AR device 104 is located, in this example France. In the example system 100, server computer 108 accesses database 110 to obtain the exchange rate. Database 110 is an example database that includes a current exchange rate. The current exchange rate is periodically updated as the exchange rate changes.

After server computer 108 obtains the exchange rate, server computer 108 sends the exchange rate to AR device 104. AR device 104 then displays the exchange rate on the optical display of AR device 104. In an example implementation, the exchange rate is projected on the optical display at the same time as the user views the banknote. Thus, at the same time that the user views the banknote with AR device 104, a current value of the exchange rate is projected as an image overlay of the banknote. As discussed earlier, AR device 104 may also display a monetary value of the banknote in a currency preconfigured for the user (for example in U.S. dollars).

When AR device 106 is used instead of AR device 104 to view the banknote, the exchange rate and monetary value of the banknote are also displayed on the optical display of AR device 106. As discussed, the example AR device 106 is a mobile device such as a smartphone or tablet computer. Typically, when a mobile device such as AR device 106 is used, the user first activates an exchange rate software application on AR device 106, for example by tapping an icon for the exchange rate software application on AR device 106. The user may then issue a verbal command to obtain the current exchange rate.

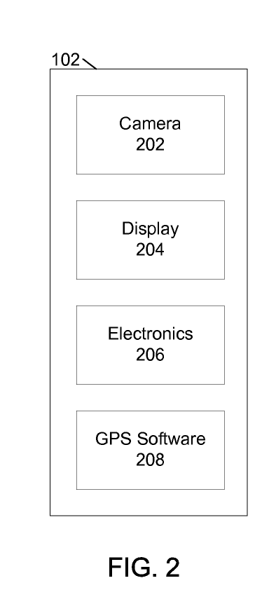

FIG. 2 shows example modules 200 of AR devices 104 and 106. The example modules 200 include a camera 202, a display 204, electronics 206 and GPS software 208. The camera 202 is a camera that is built-in to AR devices 104 and 106. Display 204 is a display that is also built-in to AR devices 104 and 106. Electronics 206 includes an electronic computing device with wireless capability. The wireless capability may include Bluetooth, radio frequency identification (RFID), mobile telecommunications, Wi-Fi, or similar types of wireless capability. GPS software 208 is typically a software application that may be installed on the mobile electronic device. When AR device 104, 106 is an AR headset, camera 202, display, 204, electronics 206 and GPS software 208 are part of the AR headset.

AR devices 104 and 106 also include optical recognition software for recognizing currency types and amounts on banknotes and other financial documents. In addition, AR devices 104 and 106 may also include a software module for interfacing the server computer 108 and with display 204 to obtain and display exchange rates and monetary values associated with the exchange rates. In some implementations, one or both of AR devices 104 and 106 may use an exchange rate software application in lieu of an exchange rate software module.

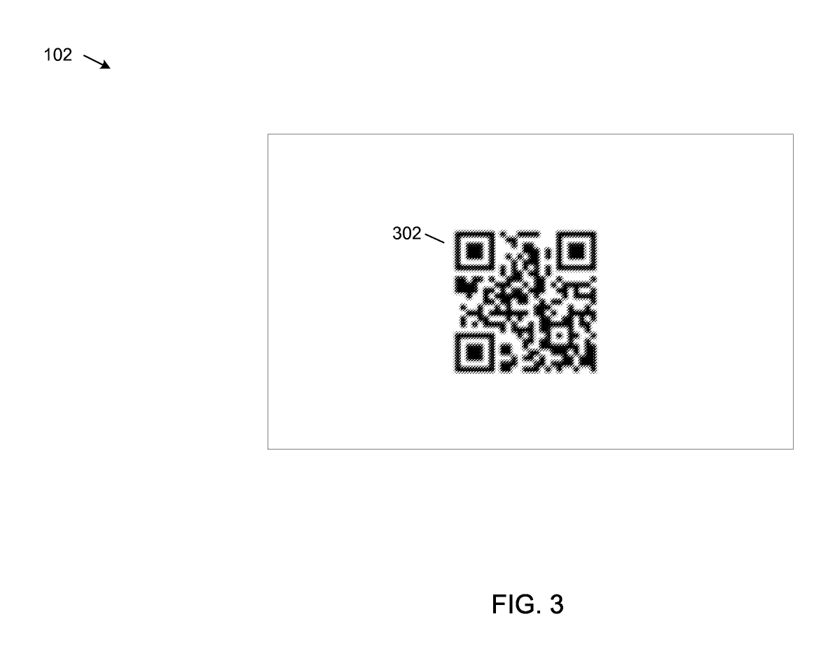

FIG. 3 shows an example QR code 302 that may appear on the item to be scanned 102. The QR code 302 is a two-dimensional barcode that may include a website address of a server computer, for example server computer 108, to which a connection is to be made in order to obtain an exchange rate. When the QR code is scanned, the connection may be made automatically. Scanning QR code 302 in this manner permits an alternative method for connecting to server computer 108. In some implementations, QR code 302 may be displayed on the optical display of AR device 104. The user may tap QR code 302 to initiate a connection to server computer 108. In other implementations, QR code 302 may appear on a document that the user has. For example a bank may provide an information card to the user with useful information while traveling overseas. The information card may include a QR code as a way to expedite a connection to an exchange rate server computer, such as server computer 108.

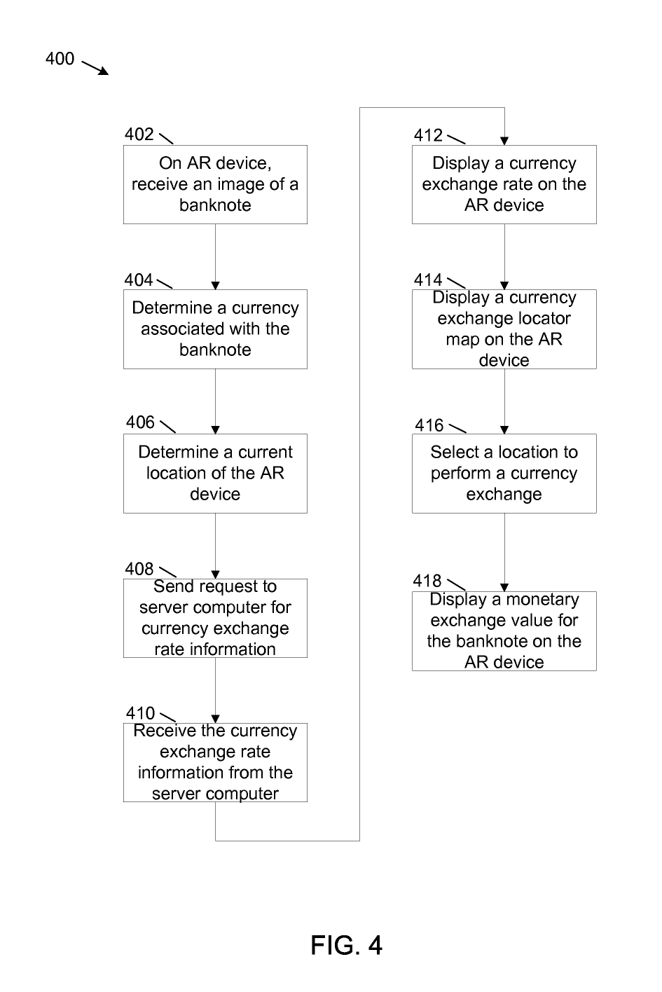

FIG. 4 shows a flowchart of an example method 400 implemented on AR device 104 for obtaining and displaying currency exchange information on AR device 104. For method 400, the currency exchange information comprises a current exchange rate, a monetary value of a banknote in a currency preconfigured for a user of AR device 104 and a locator map displaying addresses, hours and fees of nearby currency exchanges.

At operation 402, an image of a banknote is received at AR device 104. The image is received when the banknote is scanned by AR device 104. The banknote is in a foreign currency, for example in euros.

At operation 404, a currency is associated with the banknote. In method 400, the currency is determined using optical recognition software on AR device 104. The optical recognition software may determine if there are distinct markings on the banknote that may identify the currency. For example, a euro banknote has the word “EURO” on each banknote. Other words or symbols on the banknote may be used to identify the currency.

At operation 406, a current location of AR device 104 is determined. The current location is determined via GPS software on AR device 104.

At operation 408, AR device 104 sends a request to a server computer, for example server computer 108, for currency exchange information. The server computer typically obtains the currency exchange information from a database, for example database 110. In an example implementation, the database is a database of a bank or financial institution. The database maintains updated currency exchange information for the bank or financial institution. The database is updated when changes to the currency exchange information are received.

In this example, the exchange information is obtained using the location of the user as provided by the GPS information calculated by the AR device 104. For example, if the GPS information indicates that the user is in France, it is assumed that the current is euros. However, if the GPS information indicates that the user is in the United Kingdom, it is assumed that the currency is in British pounds. In another example, the user can manually provide the relevant currency information (e.g., through voice and/or typing) that is used to obtain the relevant exchange rates.

At operation 410, AR device 104 receives the currency rate information from the server computer. The currency rate information may include a current currency exchange rate and a locator map for nearby currency exchanges. Other currency rate information is possible.

At operation 412, the currency exchange rate is displayed on the optical display of AR device 104. The currency exchange rate is typically displayed as a projection on the optical display so that the currency exchange rate overlays a view of the banknote on the optical display. The currency exchange rate is a rate at which the local currency (for example euros) is converted to the currency preconfigured for the user of AR device 104 (for example dollars).

At operation 414, a currency exchange locator map is displayed on the optical display of AR device 104. The currency exchange locator map displays addresses and hours of operation for locations nearby AR device 104 at which currency may be exchanged (for example from euros to dollars or vice-versa). The locations of the currency exchanges are based on a current location of AR device 104, as determined by GPS software on AR device 104. In addition to displaying addresses and hours for the nearby currency exchanges, the locator map may also display exchange fees and any discounts that may be available to the user at the currency exchanges. The user may qualify for the discounts based on a bank account, a credit account, a debit account or other user account.

At operation 416, the user of AR device 104 selects a location at which to perform a currency exchange. The user may make a selection based where the currency exchange is located, what the exchange fees are at the currency exchange and whether any discounts are available to the user at the currency exchange.

At operation 418, AR device 104 displays a monetary value of a currency exchange for the banknote for the currency exchange location selected at operation 416. In method 400, AR device 104 calculates the monetary value based on the face value of the banknote in the foreign currency, the current exchange rate and any exchange fees or discounts that may apply.

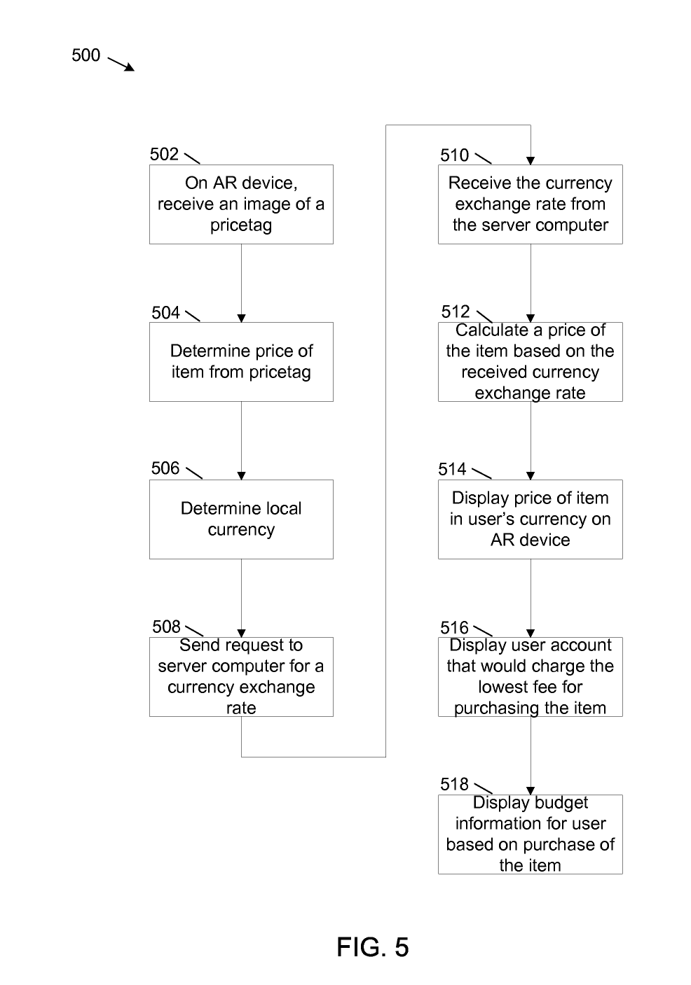

FIG. 5 shows a flowchart of an example method 500 implemented on AR device 104 for obtaining and displaying a price of an item to be purchased and budgeting information on AR device 104. The price of the item to be purchased is displayed in a currency preconfigured for the user of AR device 104. The budgeting information provides a summary of expenditures and available funds in the currency preconfigured for the user of AR device 104.

At operation 502, an image of a price tag is received at AR device 104. The image is received when the price tag is scanned by AR device 104. The price tag is attached to an item that the user of AR device 104 may be considering purchasing. The price tag is in a foreign currency, for example in euros.

At operation 504, the price of the item in the foreign currency is determined from the price tag. Optical recognition software on AR device 104 is used to determine the price of the item from the scanned price tag.

At operation 506, the local currency is determined. In method 500, the local currency is determined from the GPS position of AR device 104. The local currency corresponds to a currency in a country determined by the GPS position. Other methods may be used to determine the local currency. For example the price tag may include a currency symbol, for example a currency symbol for euros. The currency symbol may be recognized via optical recognition software on AR device 104.

At operation 508, AR device 104 sends a request to a server computer, for example to server computer 108, for a currency exchange rate. The currency exchange rate is a current rate for converting the local currency (for example euros) into a currency (for example dollars) that is preconfigured for the user of AR device 104. The currency exchange rate is obtained from a database, for example database 110.

At operation 510, the currency exchange rate is obtained from the server computer.

At operation 512, AR device 104 calculates a price of the item in the currency preconfigured for the user of AR device 104. The calculation is based on the received currency exchange rate and the face value of the item in the local currency as determined by the optical recognition software on AR device 104.

At operation 514, the price of the item in the currency preconfigured for the user of AR device 104 is displayed on the optical display of AR device 104. The price may include exchange fees. This allows the user to know an actual cost of the item in the preconfigured currency, for example U.S. dollars.

At operation 516, a user account that would charge a lowest fee for purchasing the item is displayed on the optical display of AR device 104. The user account, pre-configured for the user, may be a bank account, a credit card account, a debit card account or other financial account. In some embodiments, fees for purchasing the item for a plurality of user accounts are displayed on AR device 104. In some embodiments, operations 514 and 516 may be combined.

At operation 518, budget information for the user is displayed on AR device 104. The budget information is based on the user purchasing the item. For method 500, the budget information comprises a budget for a vacation trip. The display of the budget information on AR device 104 shows the amount budgeted for the trip in the local currency (for example dollars) of the user and the amount already spent, including the purchase price of the item, in the local currency of the user. By displaying the budget information in the local currency of the user, the user can easily see how a purchase of the item in the foreign currency affects the budget for the vacation. Other types of budget information are possible, for example budget information for a business trip.

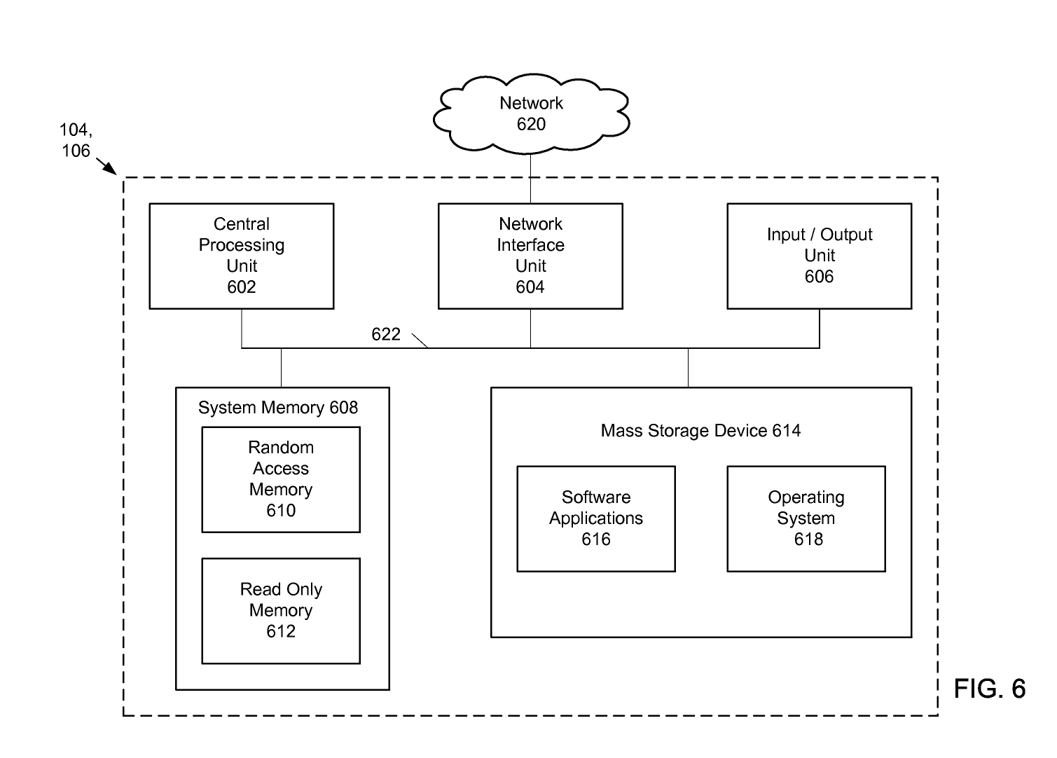

As illustrated in the example of FIG. 6, AR device 104 includes at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the AR device 106, such as during startup, is stored in the ROM 612. The AR device 106 further includes a mass storage device 614. The mass storage device 614 is able to store software instructions and data. A central processing unit, system memory and mass storage device similar to that in FIG. 6 are also included in AR device 106.

The mass storage device 614 is connected to the CPU 602 through a mass storage controller (not shown) connected to the system bus 622. The mass storage device 614 and its associated computer-readable data storage media provide non-volatile, non-transitory storage for the AR device 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the AR device 106.

According to various embodiments of the invention, the AR device 106 may operate in a networked environment using logical connections to remote network devices through the network 620, such as a wireless network, the Internet, or another type of network. The AR device 106 may connect to the network 620 through a network interface unit 604 connected to the system bus 622. It should be appreciated that the network interface unit 604 may also be utilized to connect to other types of networks and remote computing systems. The AR device 106 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the AR device 106 can store software instructions and data. The software instructions include an operating system 618 suitable for controlling the operation of the AR device 106. The mass storage device 614 and/or the RAM 610 also store software instructions, that when executed by the CPU 602, cause the AR device 106 to provide the functionality of the AR device 106 discussed in this document. For example, the mass storage device 614 and/or the RAM 610 can store software instructions that, when executed by the CPU 602, cause the AR device 106 to display received financial data on the display screen of the AR device 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an augmented reality (AR) device, the method comprising:
receiving an image of a price tag of an item to be purchased from which a monetary value may be identified as a result of viewing the price tag with the AR device, the monetary value being in a foreign currency;
at the AR device, processing an action to obtain currency exchange rate information for the item;
obtaining the currency exchange rate information from a server computer;
displaying the currency exchange rate information as an overlay of the price tag on an optical display of the AR device.

2.-3. (canceled)

4. The method of claim 1, wherein the currency exchange rate information comprises a current exchange rate for the monetary value that is identified for the item.

5. The method of claim 1, wherein the currency exchange rate information comprises a monetary value for the item in a currency preconfigured for a user of the AR device.

6. The method of claim 5, wherein the monetary value for the item in the currency preconfigured for the user of the AR device includes any fees associated with a currency exchange for the item.

7. The method of claim 1, wherein processing an action to obtain currency exchange rate information for the item comprises processing a verbal command received from the user of the AR device.

8. (canceled)

9. The method of claim 1, further comprising:
using global positioning system software on the AR device to determine a GPS location of the AR device; and
determining a local currency based on the GPS position of the AR device.

10. The method of claim 1, further comprising determining the monetary value associated with the item using optical recognition software on the AR device.

11. The method of claim 1, further comprising displaying on the AR device an identification of a user account that would charge a lowest fee for purchasing the item.

12. The method of claim 1, further comprising displaying a budget summary for the user of the AR device, the budget summary including any exchange fees and credit card charges during a specified time period.

13. The method of claim 1, further comprising displaying a locator map on the AR device, the locator map showing a location of currency exchanges nearby a current position of the AR device.

14. The method of claim 13, further comprising displaying one or more of exchange fees, discounts, and hours for the currency exchanges nearby the current position of the AR device.

15. The method of claim 1, further comprising:
receiving at the AR device images of one or more expense receipts; and
generating an expense report including the one or more expense receipts.

16. The method of claim 1, further comprising: storing a record of a transaction regarding obtaining a currency exchange rate; and
using the record of the transaction to perform a currency exchange using the currency exchange rate at a date later than a date at which the transaction occurred.

17. A method implemented on an augmented reality (AR) electronic device, the method comprising:
using the AR device to capture an image of a banknote;
using global positioning system (GPS) software on the AR device, determining a geolocation of the AR device;
using the geolocation of the AR device, determining a local currency associated with the banknote, the local currency being a currency associated with a country corresponding to the geolocation;
sending a request to a server computer to obtain an exchange rate for the local currency, the exchange rate being in a currency preconfigured for the user of the AR device;
receiving the exchange rate from the server computer; and
displaying the exchange rate on an optical display of the AR device as an overlay on the banknote.

18. The method of claim 17, further comprising:
calculating a monetary value of the banknote in the currency preconfigured for the user of the AR device using the exchange rate obtained from the server computer, the monetary value including any fees associated with performing a currency exchange for the banknote; and
displaying the monetary value of the banknote on the optical display of the AR device.

19. The method of claim 17, further comprising displaying a locator map on the AR device, the locator map showing a location of currency exchanges nearby a current position of the AR device.

20. (canceled)
